(19) United States
(12) Patent Application Publication
(10) Pub. No.: US 2002/0099858 A1
(43) Pub. Date: Jul. 25, 2002

(54) Network communications protocol

(75) Inventors: Jonathan Lindo, daly City, CA (US); Mark Barnes, Sunnyvale, CA (US); Howard Abrams, San Mateo, CA (US)

Correspondence Address: Andrew V. Smith, Sierra Patent Group, P.O. Box 6149, Stateline, NV, 89449, US

(73) Assignee: Muse Corporation

(21) Appl. No.: 09/923,771

(22) Filed: Aug. 6, 2001

Related U.S. Application Data
(60) Provisional application No. 60/231,839, filed on Sep. 6, 2000.

(51) Int. Cl. G06F 15/16; G06F 9/00

(52) U.S. Cl. 709/250; 709/328

(57) ABSTRACT

A network communications protocol program includes an active protocol stack and an inactive protocol stack, wherein a component from the inactive stack may be called into the active stack when a particular data communications type is detected. The component may be deactivated when the particular data communications type is finished. The program preferably includes socket layer, channel layer and message handling layer components for permitting and extracting communications over a network. The socket layer component receives data from a sender over a network, and defragments and reassembles the data for multiplexing and distributing data portions into multiple channels according to the data formats the data portions resemble. The channel layer component includes channels arranged according to the multiple data formats. The channel layer receives the data portions processed by the socket layer and multiplexes and distributes new data portions according to which of multiple APIs the data is directed to. The message handler component includes the APIs and receives and handles the data processed by the channel and socket layers according to user-defined responsibilities each of the APIs is configured to perform. The program is also configured for sending data over the network to multiple recipients.

### PRIORITY

This application claims the benefit of priority to United States provisional patent application No. 60/231,839, filed Sep. 8, 2000.

### BACKGROUND OF THE INVENTION

1. Field of the Invention

The invention relates to a networking protocol, and particularly to a flexible, application based protocol stack or suite capable of providing an appropriate transport mechanism in run time to permit efficient communications between multiple users running developer- and user-defined handlers.

2. Discussion of the Related Art

A protocol is a set of rules by which two or more computers communicate over a network connection. Some common protocols are TCP/IP (Transmission Control Protocol/Internet Protocol), UDP (User Datagram Protocol), IPX, NetBEUI (NetBIOS Extended User Interface), and more, each provides unique characteristics suitable for a particular application or data network. Typically, there are various applications running over a network, some applications perform better with one protocol than others. For example, FTP (file transfer protocol) is good for transferring files between two network nodes but is not suitable for real-time applications such as video streaming delivery over a data network. Therefore a new protocol is desired to provide enough flexibility to support various applications over one or more data networks. In many situations, a protocol needs to be enhanced to support features uniquely provided by an application. Thus, there is another need for a new protocol that provides a dynamic architecture to permit additional layers readily added in so that the unique features could be supported without a need to rewrite another protocol.

### SUMMARY OF THE INVENTION

The present invention has been made in consideration of the above described problems and needs. The disclosed invention provides a protocol mechanism or suite suitable for protocol management by a user or developer. The protocol management permits the developer, for example, to insert, delete, and/or update one or more protocols in the protocol suite that is uniquely designed to facilitate run-time adoption of an appropriate protocol to support one or more communication needs between two or more entities across a data network.

In a first aspect of the invention, a network communications protocol program running on at least one of a network of computers permits and extracts communications from TCP/IP between hardware components including a plurality of processors connected over the computer network corresponding to one or more senders and a user of the communications. A network layer, such as an interface or socket layer component, communicating directly with a network receives data packets from a sender over the network, and defragments and reassembles the data packets to form first layer data portions. A channel layer component receives the first layer data portions and further multiplexes and distributes the data as second layer data portions to one or more channels according to the header information in each of the second layer portions. A message handler component includes APIs for receiving and handling the data after processing by the channel layer according to user-defined responsibilities each of said APIs is configured to perform.

In a second aspect of the invention, a network communications protocol program running on at least one of a network of computers permits and extracts communications from TCP/IP between hardware components including multiple processors connected over the computer network corresponding to a user and one or more receivers of communications from the user. A message handler component includes APIs for handling second layer data portions according to user-defined responsibilities each of the APIs is configured to perform. The message handler configures the data for distribution to one or more channels according to which of multiple formats each portion of the data resembles. A channel layer component controls/manages the channels arranged according to the multiple formats each of the portion of data received from the message handler that the data portions resemble. The channel layer multiplexes and channels the data portions depending on instructions from the message handler. A socket layer component receives, multiplexes, disassembles and fragments the data from each of the channels to form data packets, and communicates those data packets over the network to one or more receivers of the communications. The socket layer may be configured to send the data packet to the one or more receivers substantially contemporaneously.

In a third aspect of the invention, a method is provided for permitting and extracting communications from TCP/IP between hardware components including multiple processors connected over the computer network corresponding to one or more senders and a user of the communications. The method includes receiving one or more data packets from a first sender via said network. The data packets are then defragmented and reassembled. The method then includes demultiplexing and distributing data portions from the data packets into one or more channels according to what format each of the data portion resembles. The data is then handled according to user-defined responsibilities each of the APIs is configured to perform.

In a fourth aspect of the invention, a method is provided for permitting and extracting communications from TCP/IP between hardware components including multiple processors connected over the computer network corresponding to a user and one or more receivers of the communications. The method includes handling data portions according to user-defined responsibilities each of multiple APIs is configured to perform. The data portions are configured for distribution to one or more channels according to what format each data portion resembles. The method further includes multiplexing and channeling the data portions according to which of the one or more channels each data portion is directed to. The data portions are then multiplexed, disassembled and fragmented into one or more data packets. The data packets are then communicated over the network to one or more receivers.

Accordingly, one of the objects of the present invention is to provide a protocol mechanism that permits efficient data flow between layers that can be the conventional ones or newly user-defined. Another one of the objects is to provide a protocol suite that facilitates run-time adoption of an appropriate protocol to support one or more communication needs between two or more entities across a data network.

Other objects, together with the foregoing are attained in the exercise of the invention in the following description and resulting in the embodiments illustrated with reference to the accompanying drawings.

### BRIEF DESCRIPTION OF THE DRAWINGS

FIG. 1a schematically illustrates a first application layer protocol stack in accord with a first embodiment.

FIG. 1b schematically illustrates an application layer protocol stack in accord with a second embodiment.

FIG. 1c schematically illustrates an application layer protocol stack in accord with a third embodiment.

FIG. 1d schematically illustrates an application layer protocol stack in accord with a fourth embodiment.

FIG. 1e schematically illustrates an application layer protocol stack in accord with a fifth embodiment.

FIG. 1f schematically illustrates an application layer protocol stack in accord with a sixth embodiment.

FIG. 2a schematically illustrates a multiplexing/demultiplexing component and feature of the socket layer.

FIG. 2b schematically illustrates components of a socket layer in accord with a preferred embodiment.

FIG. 3a schematically illustrates components of a channel layer in accord with a preferred embodiment.

FIG. 3b schematically illustrates a multiplexing/demultiplexing component and feature of the channel layer.

FIG. 4a illustrates components of a message handler in accord with a preferred embodiment.

FIG. 4b illustrates dynamic characteristics of an application based protocol by virtue of the present invention according to one embodiment thereof.

FIG. 5a illustrates a first method in accord with the invention including receiving a message from a network.

FIG. 5b illustrates a second method in accord with the invention, including the method of FIG. 5a and a decompression/decryption step.

FIG. 5c illustrates a third method in accord with the invention including the method of FIG. 5a and a session monitoring step.

FIG. 5d illustrates a fourth method in accord with the invention including the method of FIG. 5a and a data aggregation step.

FIG. 5e illustrates a fifth method in accord with the invention including the method of FIG. 5a and one or more steps involving developer defined responsibilities.

FIG. 5f illustrates a sixth method in accord with the invention including the method of FIG. 5a and a decompression/decryption step, a session monitoring step, a data aggregation step, and one or more steps involving developer defined responsibilities.

FIG. 6a illustrates a seventh method in accord with the invention including sending a message using a network.

FIG. 6b illustrates a eighth method in accord with the invention including the method of FIG. 6a and a compression/encryption step.

FIG. 6c illustrates a ninth method in accord with the invention including the method of FIG. 6a and a session monitoring step.

FIG. 6d illustrates a tenth method in accord with the invention including the method of FIG. 6a and a data aggregation step.

FIG. 6e illustrates an eleventh method in accord with the invention including the method of FIG. 6a and one or more steps involving developer defined responsibilities.

FIG. 6f illustrates a twelfth method in accord with the invention including the method of FIG. 6a and a compression/encryption step, a session monitoring step, a data aggregation step, and one or more steps involving developer defined responsibilities.

### DETAILED DESCRIPTION OF THE PREFERRED EMBODIMENTS

The preferred network environment for implementing the present invention is a three-dimensional (3D), multi-user shared environment. Some aspects of the preferred networking environment have been illustrated and described at U.S. patent application Ser. Nos. 09/498,632, 09/375,476, 60/096,884, and 09/518,552, each of which is assigned to the same assignee as the present application and is hereby incorporated by reference.

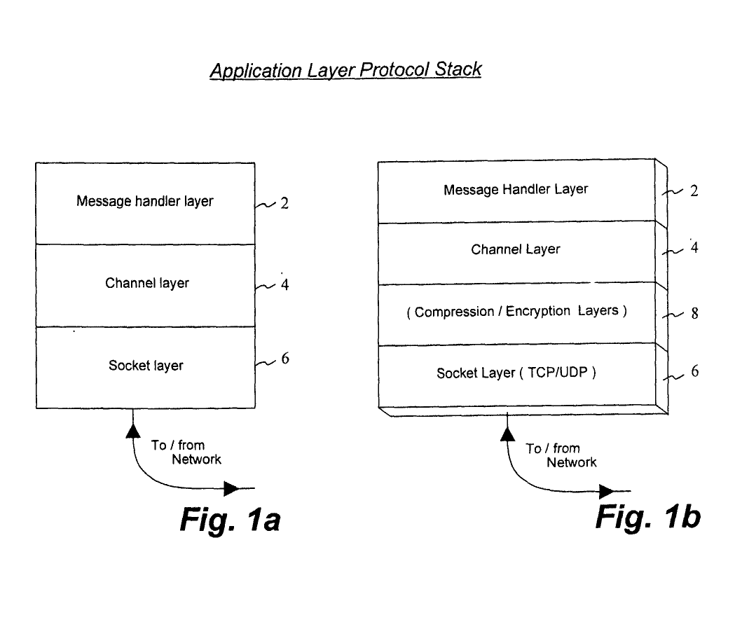

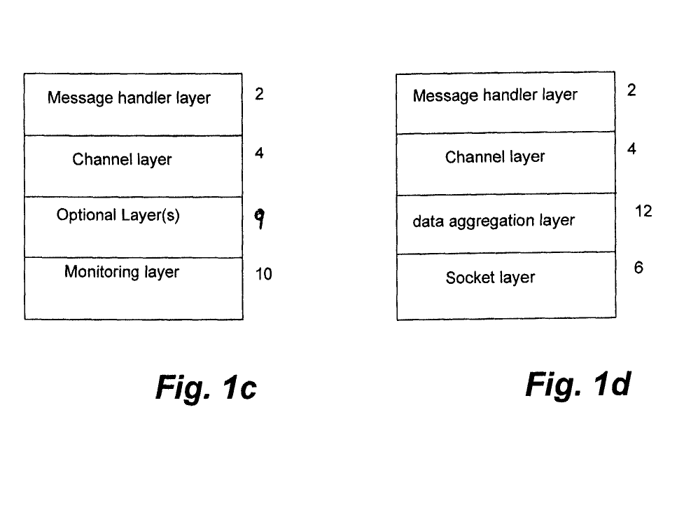

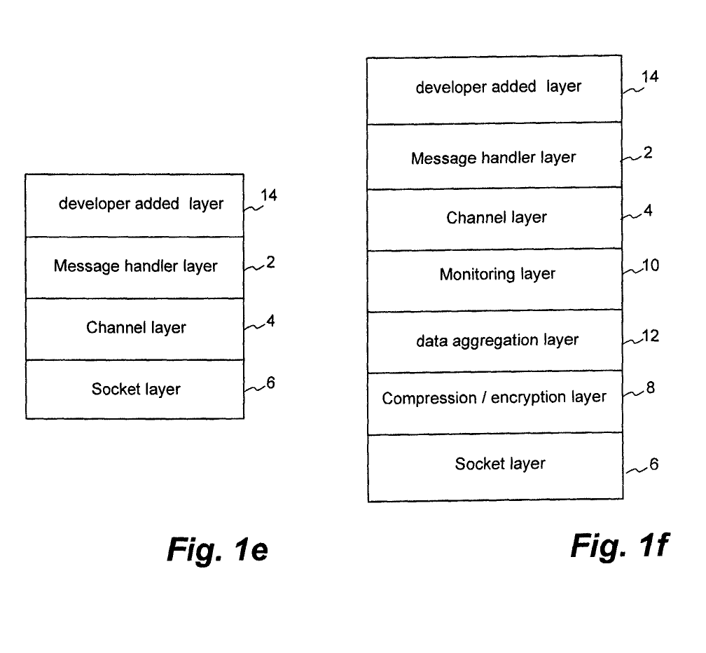

FIG. 1a schematically illustrates an application layer protocol stack in accord with a first embodiment of the present invention. The protocol stack of the first embodiment is preferably a portion or generalization of a total client/server software program, and may be used with an operating system. The program is preferably running on a network capable device such as a personal computer, a set top box, a cellular phone or a pager. The network may be the Internet, a wide area network (WAN) or a local area network (LAN).

The protocol stack of the first embodiment is preferably a lower layer networking protocol, just above IP (Internet Protocol) layer. The protocol automatically permits extraction of communications from TCP, UDP, Net BEUI, IPX, or other network information exchange format. The protocol exhibits transport mechanism ambiguity, wherein communications may be exchanged with the network in any of the above or other protocols. An advantage of this feature of the first embodiment is that protocols may be switched on the fly to ensure an appropriate transport mechanism is consistently being used.

The protocol of the first embodiment also features heterogeneous platform support. Through standardization of protocol semantics, communication between devices of differing hardware and/or software operating systems is supported. The protocol of the first embodiment also features network bandwidth optimization. As a result of optimization techniques including, but not limited to, message aggregation, compression and header field re-mapping, network bandwidth usage is optimized for broadband services. These services typically require large amounts of streaming, synchronous data to be delivered in a timely, reliable fashion often with limited bandwidth resources available.

The protocol of the first embodiment also features distinct priority level support. The ability to assign priority levels to different channels of data is key to ensuring the reliable delivery of critical data, as well as the appropriate allocation of processing resources to each communication channel in use by a particular system.

The protocol of the first embodiment also features an easy to use, powerful network application SDK. By abstracting core elements of network data delivery, an intuitive, efficient and easy-to-use API is presented to the developer. This allows him or her to quickly create network-enabled applications using the Muse network infrastructure.

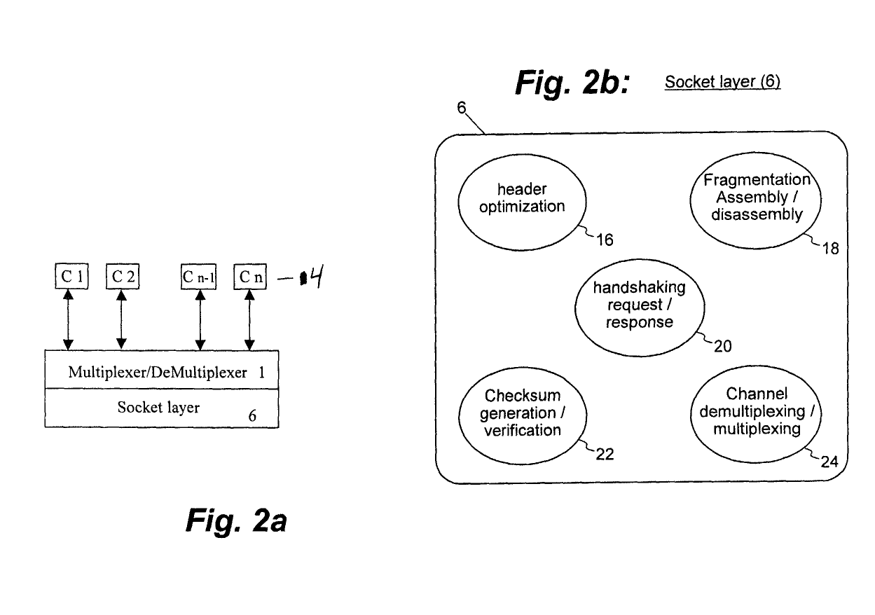

The protocol stack of FIG. 1a includes a message handler layer 2, a channel layer 4 and a socket layer 6. It should be noted that the socket layer 6 is used as an example of a network interface between a data network and the protocol stack shown in FIG. 1a. There may be other methods that can be used to implement a network interface. Hence the socket layer as will be used throughout the description herein shall not be interpreted as a limitation to the invention. The message handler 2 includes one or more APIs. The message handler 2 is configured to generate messages based on inputs from a user. The message handler 2 preferably configures the message further based on developer- and user-defined responsibilities of some or all of the APIs, and may also use predetermined or calculated inputs not directly included with the user input. The message handler 2 configures the message as data to be received by a channel that may be inserted by a user. As an example, the channel layer 4 is placed between the message handler layer 2 and the socket layer 6, and so provides the data depending on the format of the data and which of the channels the data is configured to be sent to. Corresponding to FIG. 1a, FIG. 2a shows an example of data being communicated between channels and the socket layers. For inbound data (i.e., data packets coming from the network), the socket layer 6 defragments and reassembles the packets into data portions. The data portions are then respectively sent to pertinent channels (some or all of C1, C2, . . . Cn) 3 through a multiplexer 1 (in the channel layer). For outbound data (i.e. data packets going to the network), the data portions are coming from pertinent channels (some or all of C1, C2, . . . Cn) 3 and are demultiplexed through a demultiplexer 1 ( also in the channel layer). The demultiplexed data are then fragmented and assembled in the socket layer 6 for transporting to the network. Each of the channels C1, C2, . . . Cn) may represent an application executed in a first computing device. The application may require data exchange in a particular format with a second computing device. Both the first and the second computing devices are coupled to the network. Examples of the format include audio, video, voice, text, data, graphic or various combinations.

Referring now back to FIG. 1a, the message handler 2 is configured to receive data from the channel layer 4. The message handler 2 then configures the data for consumption by the user, such as by converting the data to text for display on a display screen or printer, or by routing the message. The way the message is handled is entirely user and/or API developer defined.

The channel layer 4 receives data from the message handler 2. The channel layer 4 demultiplexes data from the message handler 2 such that data configured based on multiple user- and developer-defined API responsibilities is sorted depending on the format of the data and which one of multiple channels the data is directed to

The channel layer 4 also follows and enforces priority rules for sending data to the socket layer 6 and to the message handler 2. Any of these priority rules may be defined by the user or the developer or may be embedded within the basic programming infrastructure, such as structures in C++ computer program language. The rules are flexible and may be modified by the user or developer as the client program evolves. Such evolution may be tracked based on actual, perceived or interpolated interests of the user or developer. The priority may depend on host and/or user interests and separate and mutual communications activities and history. The priority may also depend on the proximity of the user and host in the network environment.

The channel layer 4 also performs host association management responsibilities. Some channels, e.g., may be associated with particular users or hosts, and the channel layer 4 recognizes and configures data automatically during exchange accordingly. The user, developer or host may specify a channel for a particular message, or for a host or user. The socket layer 6 communicates directly with the network. The socket layer 6 receives messages (i.e., the packets) from the network and facilitates a demultiplexing of the messages into appropriate channels by the channel layer 4. Typically, before a communication session for receiving or sending data with another socket layer in another computing device, the socket layer 6 exchanges a handshaking with another socket layer (e.g., receives a handshaking request and responds). After the session is established, among other functions, the socket layer 6 performs checksum verification of the incoming message and/or generation of an outgoing message. For the incoming message,the socket layer 6 also defragments and reassembles the received data and reads the message header for processing accordingly and for further use of the header data by the channel layer 4.

The channel layer 4 demultiplexes data received from the network. The data may be sorted according to which of multiple channels the data is configured for or directed to. The channel layer 4 may have instructions for channeling of particular data and may have general instructions as to the sorting of received data.

For the outgoing message, the socket layer 6 receives data from the channel layer 4 and prepares the data for transport to the network. Specifically, the data from one or more channels are demutiplexed in the channel layer 4. The demultiplexed data are sent to the socket layer 6 for transporting to the network. The socket layer 6 performs checksum generation of the outgoing message. The socket layer 6 also fragments and reassembles the data received from the multiple channels of the channel layer 4. The socket layer 6 also optimizes the header of the outgoing message by modifying the header data received from the channel layer 4.

The socket layer 6 receives data from the channel layer 4. The data may be received according to priorities for each of the one or more channels, or otherwise as defined by the user or developer. The socket layer 6 may have instructions for sending particular messages and may have general instructions as to the priorities of particular hosts, messages or channels.

FIG. 1b schematically illustrates an application layer protocol stack in accord with a second embodiment. The second embodiment includes the message handler 2, channel layer 4 and socket layer 6 substantially in accord with the first embodiment. The protocol of the second embodiment further includes a compression/ encryption layer 8. When a message is being sent by the user, the message may utilize the compression and/or encryption features of the compression/encryption layer 8 depending on a particular application. For example, when a hypertext file is being transferred between two computing devices, the protocol stack as shown in FIG. 1a may be sufficient. But when an application is launched in one computing device, that application involves video streaming downloading from one or more other computing devices, and a compression/encryption layer is used. Hence the protocol stack as shown in FIG. 1b is desired. When a message is being received, the compression/encryption layer 8 may function to decompress and/or decrypt the incoming message accordingly. It is noted that the addition of the compression/encryption layer 8 to the protocol stack as shown in FIG. 1a, hence FIG. 1b, is carried out automatically and in run time. In other words, the compression/encryption layer 8 is added in only when the pertinent application starts. More importantly, as will be further described below, a protocol layer is only called on (i.e., added in) when such use thereof will attain higher efficiency of the application.

FIG. 1c schematically illustrates an application layer protocol stack in accord with a third embodiment. The third embodiment includes the message handler 2, channel layer 4 and socket layer 6 substantially in accord with the first embodiment. The protocol of the third embodiment further includes a monitoring layer 10 and an option layer 8. Except that the socket layer 6 and the message handler layer 2 are preferably at the bottom and the top of a protocol stack, respectively, the layers therebetween could be in any order. Specifically, the monitoring layer 10 tracks the incoming and outgoing communications history of an application or a user and provides a mechanism for users/developers to closely monitor data status, gather data statistics and other parameters, all obtained right before the data are sent out to or right after the data are received from the network. The monitoring layer 10 electronically stores data in memory relating to activities of the user and maintains a pointer table for retrieving past history and for efficient filing of further events, hence the users know if the data are transported in a desired way at desired performance. Particular histories between the user and particular other users and hosts are also monitored and maintained. The optional layer 9 is shown in the FIG. 1 c, illustrating the feature that any of a number of other layers may be placed there to facilitate transport efficiency of certain data types used by an application. One example is the compression/encryption layer 8 shown in FIG. 1b.

FIG. 1d schematically illustrates an application layer protocol stack in accord with a fourth embodiment. The fourth embodiment includes the message handler 2, channel layer 4 and socket layer 6 substantially in accord with the first embodiment. The protocol of the fourth embodiment further includes a data aggregation layer 12. The data aggregation layer 12 is configured to aggregate data from one or more sources so that the data can be transported more efficiently over a data network. The sources may be a number of different applications being currently in use and each of the applications is transferring data with a network node (another device on the network). If the data from the applications are not substantially long, the data aggregation layer 12 will aggregate the data accordingly to maximize the use of the bandwidth of the network. In one implementation, packets from different sources are simply repacked into an aggregated packet with its own data header. The aggregated packet is then dispersed at a corresponding data aggregation layer of the node and each of the individual packets then proceeds with its own destination address.

FIG. 1e schematically illustrates an application layer protocol stack in accord with a fifth embodiment. The fifth embodiment includes the message handler 2, channel layer 4 and socket layer 6 substantially in accord with the first embodiment. The protocol of the fifth embodiment further generally includes a developer added layer 14. The developer added layer 14 allows the protocol to be flexible and modifiable as developers create new and modified communication techniques. The developer added layer 14 also allows a developer to craft the protocol of the fifth embodiment to meet his goals, while maintaining the advantages provided by the message handler 2, channel layer 4 and socket layer 6. As described above, the message handler layer 2 configures data for consumption by user, for example, converting data to text or vice versa. Thus a higher-level user-defined layer can be readily added. For example, a video streaming application is supported by simply adding a Real-Time Transport Protocol (RTP) on top of the message handler layer if desired.

FIG. 1f schematically illustrates an application layer protocol stack in accord with a sixth embodiment. The sixth embodiment includes message handler layer 2, the channel layer 4 and the socket layer 6 substantially in accord with the first embodiment. The sixth embodiment further includes the compression/encryption layer 8 of the second embodiment, the monitoring layer 10 of the third embodiment, the data aggregation layer 12 of the fourth embodiment, and the developer added layer 14 of the fifth embodiment. It should be noted that layers 4, 8, 10, 12 may be in any order and not every one of them must be present in supporting communications between/among entities on a data network. Hence, other embodiments within the scope of the invention include other combinations of the layers 2-14 described above.

FIG. 2b illustrates components of a socket layer 6 in accord with a preferred embodiment. The socket layer 6 is preferably included with embodiments that were mentioned above and respectively illustrated in FIG. 1a-FIG. 1f. The socket layer 6 configures incoming messages for further processing by the channel layer 4 and subsequent layers as well as configures outgoing messages for transmission over the network to one or more recipients (i.e., other entities on the network).

The socket layer 6 includes a header optimization component 16, a fragmentation assembly/disassembly component 18, a handshaking request/response component 20, and a checksum generation/verification component 22. The socket layer 6 may have further components and may have fewer than all of these components 16-24.

The header optimization component 16 works with the header of an outgoing message so that the header can be efficiently used by the recipient of a message depending on the configurations and settings of the machine and the software the recipient is using and running. The header optimization component 16 of the socket layer 2 may know how best to optimize data in the header of an outgoing message from past history or the user or between the user and the recipient or recipients, information obtained during handshaking (see below), and/or information specifically configured by the user for the outgoing message. The header optimization also works with the information contained in the headers of incoming messages for efficient processing by the channel layer 4, message handler layer 2 and any other layers of the protocol (see, e.g., layers 8-14).

The fragmentation assembly/disassembly component 18 of the socket layer 2 works with data packets of incoming or outgoing messages. The outgoing message may be first fragmented into a number of packets if the message is too long or exceeding a normal length of a packet or two or more outgoing messages are aggregated if they are going to the same destination to best use the bandwidth of the network. Incoming packets may be first de-aggregated or reassembled to form incoming messages for channeling processing in a subsequent channel layer if there is one.

The fragmentation assembly/disassembly component 18 also works with data contained in outgoing messages. Data in multiple formats and from multiple channels is received at the socket layer 2 from the channel layer 4. The fragmentation assembly/disassembly component 18 then prepares all of the data contained in the message into data packets arranged for optimum transmission over the network to the recipient or recipients. Thus, the data packets of the outgoing message may thus be rearranged from what is received at the socket layer 6 from the channel layer 4 depending on the routes they will travel to get to the recipients such that the transmission is optimal. On the other hand, data packets of incoming messages are defragmented and reassembled according to their content, information relating to the sender, the priority of the content and the configuration of the user system.

The handshaking request/response component 20 receives/sends handshaking requests from/to senders at the socket 6 prior to messages being transmitted to/from other entities on the network. When a handshaking request is received, a response is sent to the sender of the request. Data included in the response may include sending information to enable efficient transmission of the message by the sender, such as information relating to the protocol configuration of the user. The handshaking request/response component 20 also processes information received in the handshaking request and any follow-up exchange between the sender and user during the handshaking process. The handshaking request/response component 20 also sends handshaking requests to a recipient or recipients of a message to be sent by the user.

The checksum generation/verification component 22 of the socket layer performs checksum generation and verification. In this way, data to be received is evaluated and data to be sent is encoded with identifiers for evaluating the authenticity of the data.

When an incoming message is received at the socket layer 6 from a sender over the network, the data is defragmented or reassembled. The processed data from the socket layer 6 are then demultiplexed to multiple channels according to which of the channels each of the assembled data portions is directed to. Each channel can be configured by the user or developer for particular purposes. As such, the channels can serve to direct information having common usages to common locations in the channel layer 4 and ultimately to the APIs in the message handler 2.

The multiplexing/demultiplexing feature for data transmission/reception by the channel layer according to multiple channels of data to/from the socket layer is illustrated in FIG. 2a. Referring to FIG. 2a, a multiplexer/demultiplexer 1 is shown for mutliplexing data as it is received by multiple channels C₁, C₂, . . . , Cₙ₋₁, Cₙ of the channel layer 4 from the socket layer 6, or alternatively, for demultiplexing data as it is received by the socket layer from the multiple channels C₁, C₂, . . . , Cₙ₋₁, Cₙ of the channel layer 4.

When an outgoing message is received at the socket layer 6 from the channel layer 4, the data is multiplexed from the multiple channels into the socket layer 6. Thus, the data from multiple channels is multiplexed and received at a common socket portal for processing of all of the data for transmission to a recipient or recipients over the network.

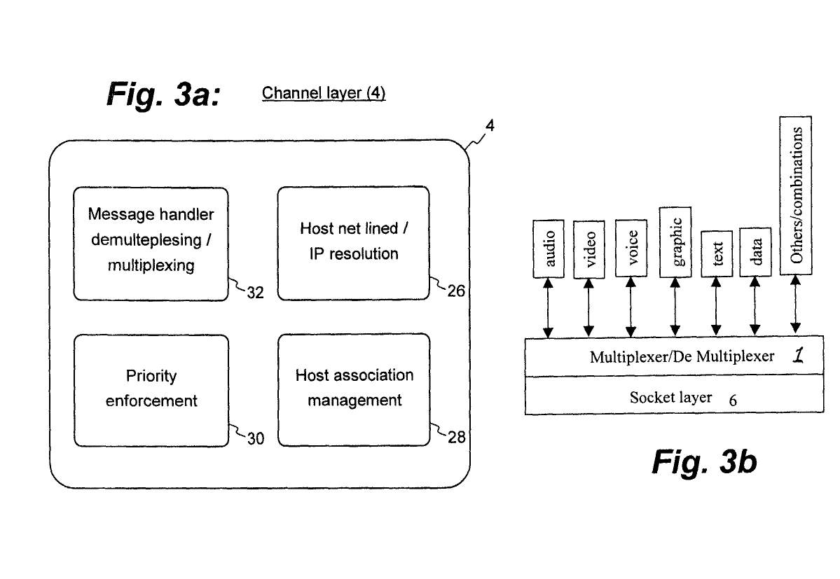

FIG. 3a illustrates components of a channel layer in accord with a preferred embodiment. The components of the channel layer 4 shown in FIG. 3a include a host URI/UUID/IP resolution component 26, a host association management component 28, a priority enforcement component 30 and a message handler demultiplexing/multiplexing component 32. Depending on an exact implementation, the channel layer 4 may include more components or may have fewer than those shown.

The host URI/UUID/IP resolution component 26 resolves unique and resource identifying information from the host, i.e., performs resolution of host URI (universal resource identifier)/ UUID (universal unique identifier)/IP for incoming messages (i.e., received from the socket layer 6) and outgoing messages (i.e., received from the message handler 2). For example, the host may be a client program residing on a PC or other network access device of another user or a server machine connected the same network as the user or to another network routed with the network of the user. The host URI/UUID/IP component 26 of the channel layer 4 uses the host URI/UUID/IP to resolve the host. Once the host is resolved, generalized data may be exchanged between the user and the host such as past communications history.

The host association management component 28 performs host association management responsibilities. Some channels, e.g., may be associated with particular users or hosts, and the host association management component 28 of the channel layer 4 recognizes and configures data automatically during communication exchanges. The user, developer or host may specify a channel for a particular message, or for a host or user.

The priority enforcement component 30 of the channel layer 4 establishes and enforces priority rules for sending data to the socket layer 6 and to the message handler 2. Any of these priority rules may be defined by the user or the developer or may be embedded within the basic programming infrastructure. The rules are flexible and may be modified by the user or developer as the client program evolves. Such evolution may be tracked based on actual, perceived or interpolated interests of the user or developer. The priorities of messages, data portions, hosts, recipients or senders may depend on host and/or user interests and separate and mutual communications activities and history. The priority may also depend on the proximity of the user and host in the network environment.

The message handler demultiplexing/multiplexing component 32 of the channel layer 4 works with the message handler layer 2 to multiplex and demultiplex data respectively following and prior to processing by the message handler layer 2. Incoming data to the channel layer 4 resides in multiple channels due to the channel demultiplexing/multiplexing component 24 of the socket layer 6. Each channel is multiplexed by the message handler demultiplexing/multiplexing component 32 whereby the data is separated depending on the format of the data. For example, the data may be audio, video, voice, graphic, text, data or a combination of two or more of these formats. The multiplexing/demultiplexing feature for data processing by the channel layer 4 according to multiple data formats is illustrated at FIG. 3b.

When an outgoing message is received at the channel layer 4 from the message handler layer 2, the data is multiplexed from the multiple formats into one or more channels of the channel layer 4. Thus, the data from multiple formats is multiplexed and received at the channels for processing of all of the data for transmission to a recipient or recipients associated with a particular channel over the network.

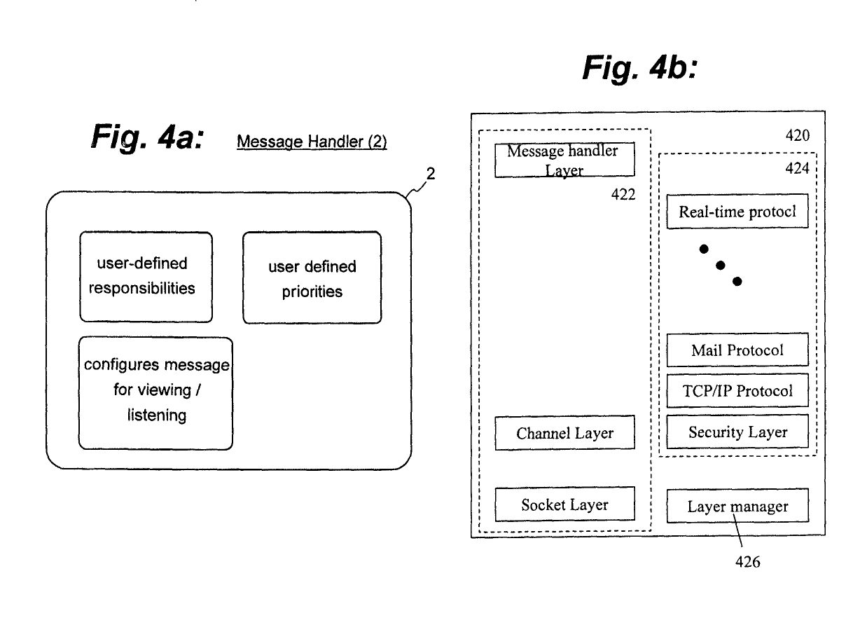

FIG. 4a schematically illustrates components of a message handler 2 in accord with a preferred embodiment. The message handler 2 couples to applications component, whereby a user may configure a message to be sent to one or more recipients via other layers, the channel layer 4 and socket layer 6 over the network. The user or developer may configure the message handler 2 to perform desired responsibilities. Priorities may be defined by the user or developer that will be enforced at the channel layer 4. Similarly he message handler 2 also configures incoming message data, for example, for viewing at a display screen or for listening using a listening device after the incoming messages received in socket layer 6 and processed in other layers. The other layers are may often be application dependent, namely, a layer will preferably be called in only when there is a need for such. If a message being transported is an encrypted email, e.g., then the other layers may include an encryption/decryption layer and a PPTP (Point to Point Tunneling Protocol) layer. When the message is complete, the encryption/decryption and PPTP layers may be called off.

Referring now to FIG. 4b, there is illustrated an application based protocol suite 420 according to one embodiment of the present invention. Suite 420 includes an active stack 422 and an inactive stack 424 in addition to a layer manager 426. As used herein, active stack 422 includes layers or protocols that facilitate communication between two network entities with respect to an active application. Generally, there are a number of fixed layers in active stack 422, such as the socket layer 6, that are preferably in to make the communication possible. To make the application run more efficiently or perform optimally, there are some callable layers in active stack 422. The callable layers are only present in active stack 422 when their presence facilitate the application to run more efficiently or perform optimally. Hence inactive stack 424 holds those that are currently used or called into active stack 422. The insertion of layers/protocols in inactive stack 424 into active stack 422 is managed by layer manager 426. In one embodiment, layer manager 426 detects what data caused by an application are being transported between two network entities. For example, when layer manager 426 detects that incoming packets are MPEG type data, the real-time protocol (TRP) in inactive stack 424 is activated to join in active stack 422 so that the MPEG type data can be transported in a way that meets the demands from the data. In operation, layer manager 426 is registered with all the available layers/protocols and may act based on the priority, security, reliability and other characteristics of the data. Layer manager 426 keeps a record of status of all the available layers/protocols in the suite so that appropriate layers/protocols could be activated when an application demands.

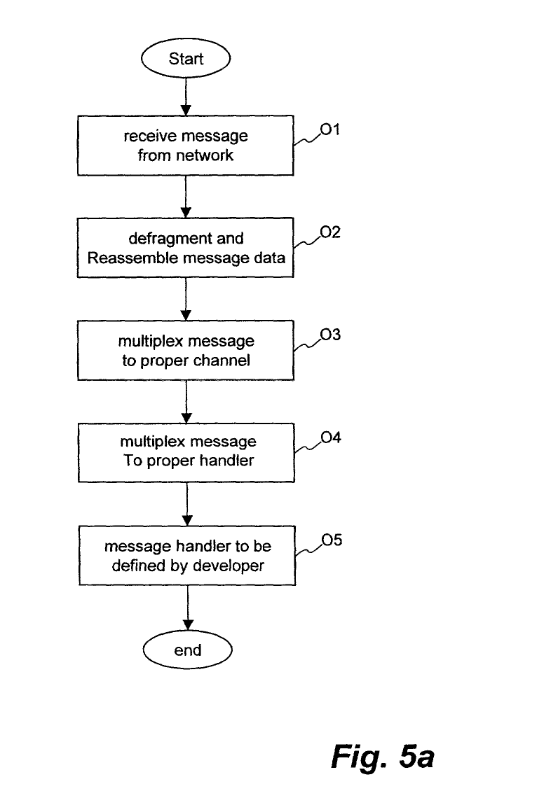

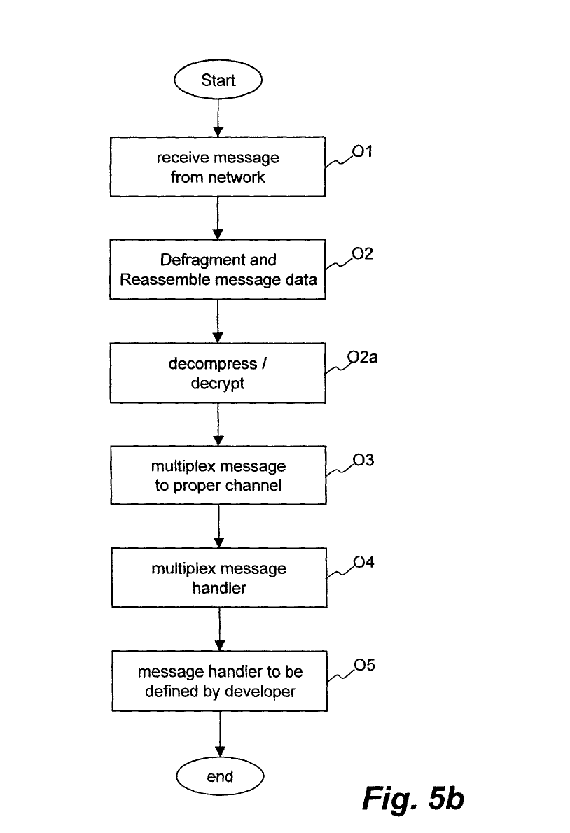

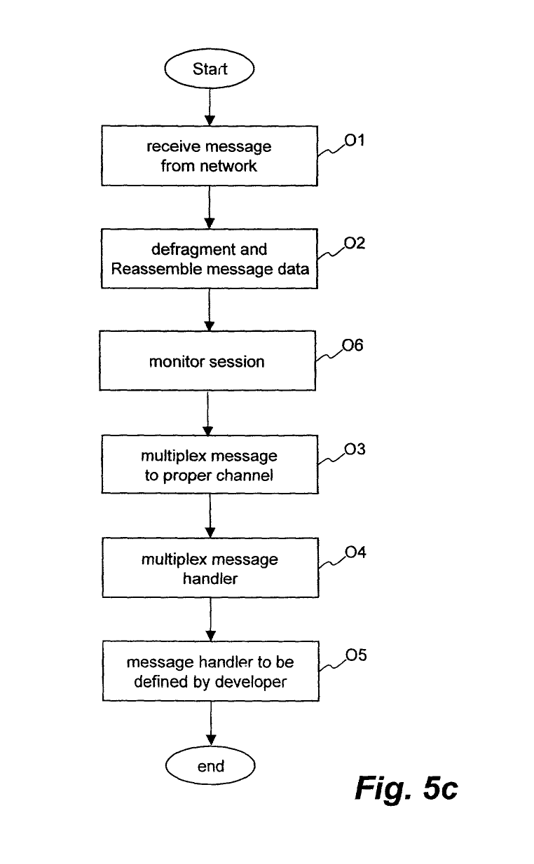

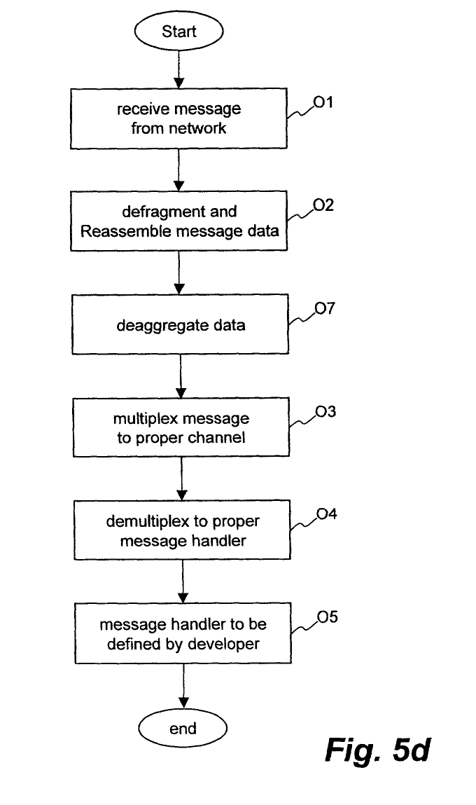

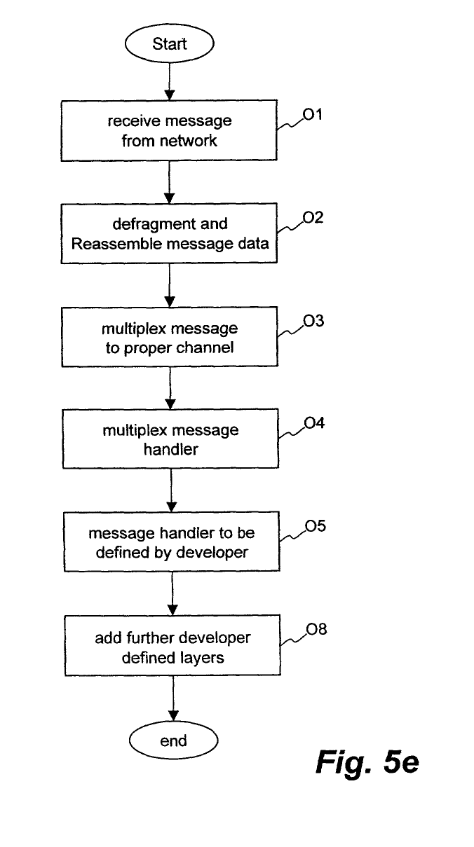

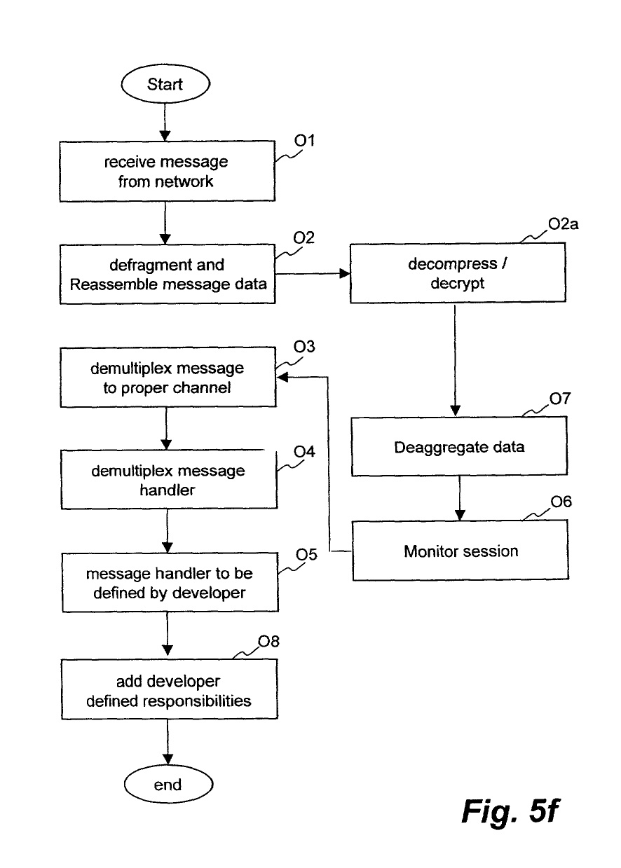

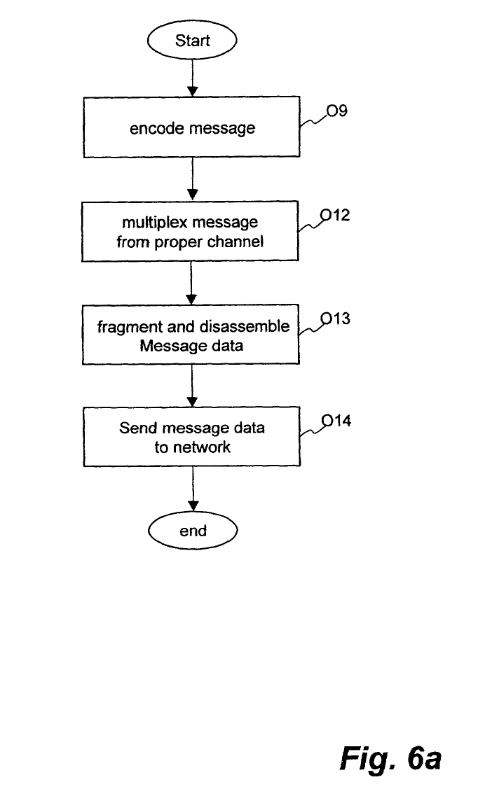

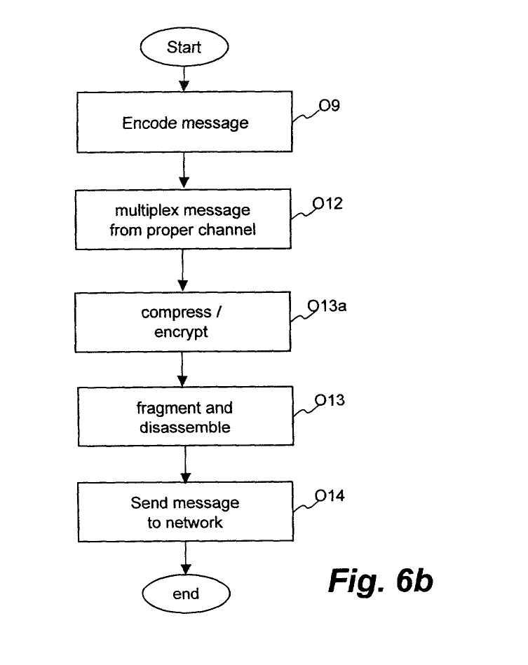

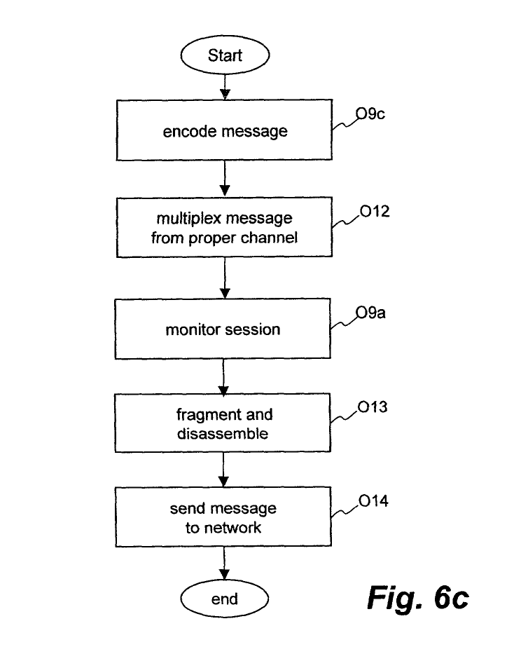

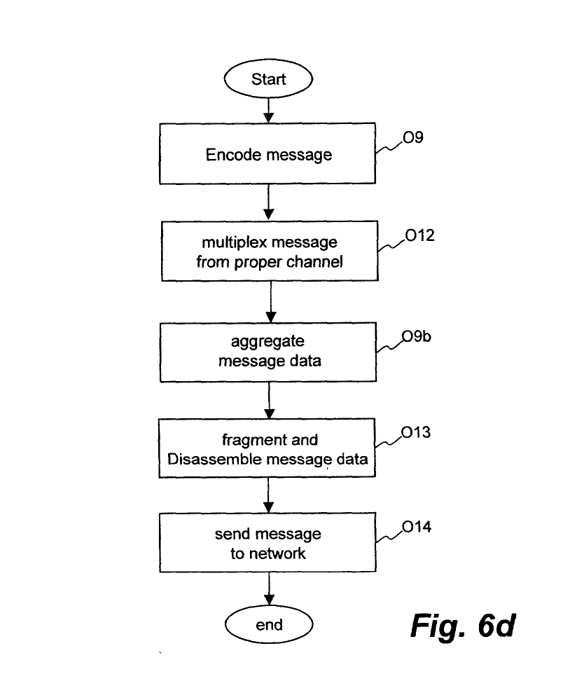

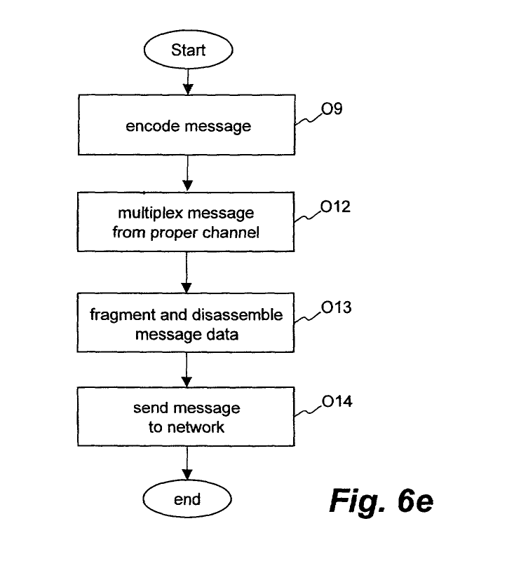

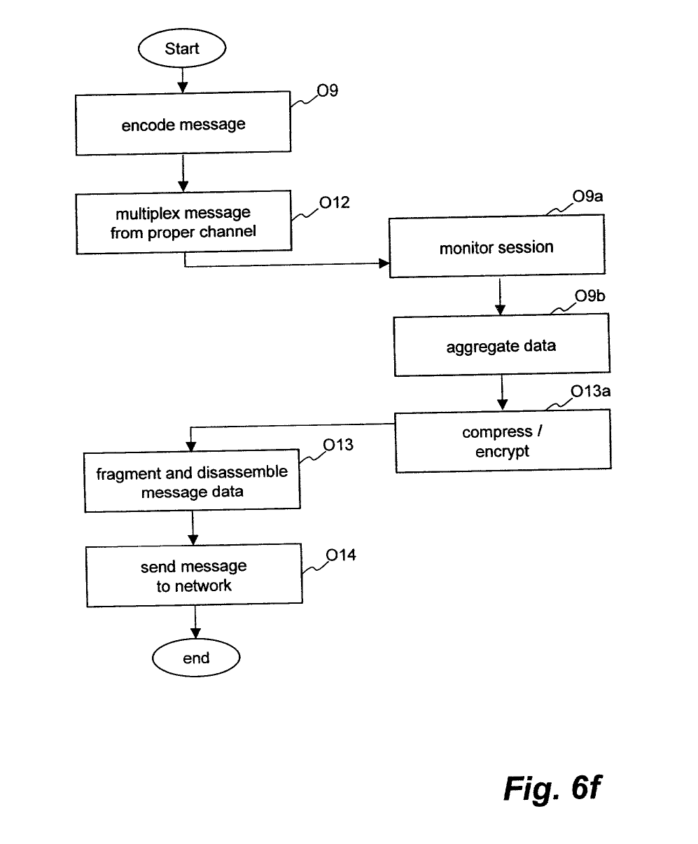

FIGS. 5a-6f show, respectively, diagrams of various implementation methods according to preferred embodiments of the present invention. The order of blocks in the diagrams does not inherently indicate any particular order nor imply any limitations in the invention.

FIG. 5a illustrates a first method of the invention in accord with the first embodiment illustrated above with respect to FIG. 1a. The method includes receiving a message from a network (O1). The message is received as one or more data packets that are fragmented and reassembled (O2). The message is than multiplexed to multiple channels (O3). The data of each of the multiple channels is then multiplexed according to the format of the data (O4). The data is then processed according to user or developer defined responsibilities (O5).

FIG. 5b illustrates a second method of the invention in accord with the second embodiment illustrated above with respect to FIG. 1b. The method includes the operations O1-O5 of FIG. 5a. The method further includes a decompression and/or decryption operation (O2a) that is performed when the incoming message is compressed and/or encrypted by the sender.

FIG. 5c illustrates a third method of the invention in accord with the third embodiment illustrated above with respect to FIG. 1c. The method includes the operations O1-O5 of FIG. 5a. The method further includes a session monitoring operation (O6) for users/developers to closely monitor data status, gather data statistics and other parameters. FIG. 5c is for a particular embodiment. As described above, the exact location of session monitoring operation (O6) could be anywhere between O1 and O5. In the example shown in the figure, the data status, statistics and other parameters will be obtained right before the data are sent out to or right after the data are received from the network.

FIG. 5d illustrates a fourth method of the invention in accord with the fourth embodiment illustrated above with respect to FIG. 1d. The method includes the operations O1-O5 of FIG. 5a. The method further includes a data aggregation operation (O7) that is configured to aggregate data from different sources so that the data can be transported more efficiently over a data network. For example, packets from different sources travel towards a destination, the packets, if appropriate, are simply repacked into an aggregated packet with its own data header. Upon arriving, the aggregated packet is then dispersed at a corresponding data aggregation layer of the node and each of the individual packets then proceeds with its own destination address.

FIG. 5e illustrates a fifth method of the invention in accord with the fifth embodiment of FIG. 1e. The method includes the operations O1-O5 illustrated above with respect to FIG. 5a. The method further includes one or more user or developer defined operations (O8) such as creating a message for requesting data, causing a handler to interpret the message and subsequently acting on the data.

FIG. 5f illustrates a sixth method in accord with the sixth embodiment of the invention illustrated above with respect to FIG. 1f. The method includes the operations O1-O5 illustrated above with respect to FIG. 5a. The method further includes a decompression/decryption operation (O2a), a session monitoring operation (O6), a data aggregation operation (O7), and one or more operations involving developer or user defined responsibilities (O8).

FIG. 6a illustrates a seventh method in accord with the seventh embodiment of the invention illustrated above with respect to FIG. 1a. The method includes configuring a message according to any of multiple formats according to rules defined for any of multiple channels (O9). The message is sent to a message handler for performing user and developer defined responsiblities (O10). The message is multiplexed such that the multiple formats are combined into data portions according to which of the multiple channels the data is directed to (O11). The data of the channels is then multiplexed further to constitute all of the data of the message (O12). The data is then fragmented and disassembled for transmission over the network (O13). The message is then sent to one or more recipients over the network (O14).

FIG. 6b illustrates an eighth method in accord with the eighth embodiment of the invention illustrated above with respect to FIG. 1b. The method includes the operations O9-O14 of FIG. 6a. The method further includes a compression and/or encryption operation (O13a). The compression and/or encryption operation (O13a) may be selected by the user and may be defaulted depending on the channel or recipient or the format of the data and the available bandwidth.

FIG. 6c illustrates a ninth method in accord with the ninth embodiment of the invention illustrated above with respect to FIG. 1c. The method includes the operations O9-O14 of FIG. 6a. The method further includes a session monitoring operation (O9a).

FIG. 6d illustrates a tenth method in accord with the tenth embodiment of the invention illustrated above with respect to FIG. 1d. The method includes the operations O9-O14 of FIG. 6a. The method further includes a data aggregation operation (O9b).

FIG. 6e illustrates an eleventh method in accord with the eleventh embodiment of the invention illustrated above with respect to FIG. 1e. The method includes the operations O9-O14 of FIG. 6a. The method further includes one or more operations involving developer or user defined responsibilities (O9c).

FIG. 6f illustrates a twelfth method in accord with the twelfth embodiment of the invention illustrated above with respect to FIG. 1f. The method includes the operations O9-O14 of FIG. 6a. The method further includes a compression/encryption operation (O13a), a session monitoring operation (O9a), a data aggregation operation (O9b), and one or more operations involving developer or user defined responsibilities (O9c).

All of the references incorporated by reference in the background above are incorporated into the preferred embodiment as describing alternative equivalent elements of the invention. Those skilled in the art will appreciate that the just-disclosed preferred embodiments are subject to numerous adaptations and modifications without departing from the scope and spirit of the invention. Therefore, it is to be understood that, within the scope and spirit of the invention, the invention may be practiced other than as specifically described above. The scope of the invention is thus not limited by the particular embodiments described above. Instead, the scope of the present invention is understood to be encompassed by the language of the claims that follow, and structural and functional equivalents thereof.

In addition, in the method claims that follow, the steps have been ordered in selected typographical sequences. However, the sequences have been selected and so ordered for typographical convenience and are not intended to imply any particular order for performing the steps.

The present invention can be implemented in a system, a method, a computer product or other format, each of which may yield one or more of the following benefits and advantages. One of them is an application based protocol suite including an active stack and an inactive stack. The protocols in the inactive stack can be activated into the active stack based on actual needs from an application. As a result, the application is performing in an optimum mode. Another one of the benefits and advantages is that the activation of the protocols in the inactive stack can be activated on the fly so that the application based protocol can be used nearly in any applications. Other benefits and advantages can be realized in the foregoing description and the appended claims.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A method for providing an application based protocol suite, the method comprising:
providing an active protocol stack to facilitate data communications across a data network; the active protocol stack including a network interface communicating directly to the data network to receive/send packets from/to the data network;
providing an inactive protocol stack in the protocol suite, the inactive protocol stack comprising a number of components, each having characteristics suitable for one type of the data communications and being registered with a protocol manger; and
activating one or more of the components from the inactive protocol stack into the active protocol stack when the one type of the data communications is detected.

2. The method of claim 1 further comprising:
deactivating the one or more of the components from the active protocol stack back to the inactive protocol stack as soon as the one type of the data communications is done.

3. The method of claim 2 wherein the activating of the one or more of the components happens concurrently when one or more applications are executed to cause the one type of the data communications.

4. The method of claim 1 wherein the deactivating of the one or more of the components from the active protocol stack back to the inactive protocol stack is caused by the protocol manger.

5. The method of claim 4 wherein the protocol manger constantly monitors any new type of the data communications from the data network.

6. The method of claim 1 wherein the network interface is a socket layer component and wherein the active protocol stack further includes a message handler component interfacing one or more applications based on the packets.

7. The method of claim 6 wherein the active protocol stack further includes a channel layer component responsible for routing/receiving the packets properly to/from each of the one or more applications.

8. The method of claim 7 wherein each of the components in the inactive protocol stack is a protocol component.

9. The method of claim 8 wherein the protocol component is a commonly used Internet protocol to support a particular data application.

10.The method of claim 9 wherein the protocol component is a user-defined protocol to support a user defined data type.

11. The method of claim 7 wherein each of the components in the inactive protocol stack is configured to have a common interface so that each of the components can be stacked one over another.

12. The method of claim 7 wherein each of the components in the inactive protocol stack and the network interface in the active protocol stack is configured to have a common interface so that each of the components can be stacked over the network interface when the each of the components is activated in the active protocol stack.

13. The method of claim 1 wherein the protocol manager keeps status of each of the components in the inactive protocol stack.

14. A network communications protocol program running on at least one of a network of computers for permitting and extracting communications from TCP/IP between hardware components including a plurality of processors connected over the computer network corresponding to one or more senders and a user of said communications, comprising:
a socket layer component for receiving one or more data packets from a first processor corresponding to a first sender via said network, and for defragmenting and reassembling data of said one or more data packets for demultiplexing and distributing first layer data portions of said one or more data packets into a plurality of channels according to which of a plurality of formats each of said first layer data portions resembles;
a channel layer component including said plurality of channels arranged according to which of said plurality of formats said data demultiplexed from said socket layer resembles, said channel layer for receiving said first layer data portions and demultiplexing and distributing second layer data portions from said first layer data portions according to which of a plurality of APIs each of said second layer portions is directed to; and
a message handler component including said plurality of APIs for receiving and handling said second layer data portions according to a plurality of user-defined responsibilities each of said APIs is configured to perform.

15. The program of claim 14, said socket layer further for associating said one or more data packets with said first sender based on header data within said one or more data packets.

16. The program of claim 14, said socket layer further for establishing a communications session between said user and said first sender, and sending a handshaking request response to said first processor.

17. The program of claim 16, said socket layer further for associating said data packet with said first sender based on header data within said data packet.

18. The program of claim 17, said socket layer further for exchanging generalized data specific to the first sender and the user.

19. The program of claim 18, said generalized data including one or more of host URI, UUID and IP.

20. The program of claim 19, said channel layer further for resolving said one or more of said host URI, UUID, and IP generalized data.

21. The program of claim 18, said generalized data including prior communication history data between said first sender and user.

22. The program of claim 14, said socket layer further for verifying and evaluating said data packet in a checksum subroutine.

23. The program of claim 14, said channel layer further for prioritizing one or both of said first and second layer data portions based on a flexible hierarchy of priorities.

24. The program of claim 23, said channel layer further for updating said flexible hierarchy of priorities as said priorities evolve based on status and activities of said user.

25. The program of claim 24, said channel layer further for updating said flexible hierarchy of priorities as said priorities evolve based on status and activities of said first sender.

26. The program of claim 23, said channel layer further for updating said flexible hierarchy of priorities as said priorities evolve based on status and activities of said first sender.

27. The program of claim 14, said plurality of formats including two or more of voice, text, data, graphic, audio, video and combinations thereof.

28. The program of claim 14, further comprising a decompression/decryption layer for decompressing and decrypting said one or more data packets depending on a state of compression and encryption of said data packets.

29. The program of claim 14, further comprising a monitoring layer for tracking data exchanges between said user and said first sender.

30. The program of claim 14, further comprising a data aggregation layer for aggregating data communicated by said first sender.

31. The program of claim 14, further comprising a developer added layer for performing responsibilities defined by a developer.

32. The program of claim 14, further comprising:
a decompression/decryption layer for decompressing and decrypting said one or more data packets depending on a state of compression and encryption of said data packets;
a monitoring layer for tracking data exchanges between said user and said first sender;
a data aggregation layer for aggregating data communicated by said first sender; and
a developer added layer for performing responsibilities defined by a developer.

33. A network communications protocol program running on at least one of a network of computers for permitting and extracting communications from TCP/IP between hardware components including a plurality of processors connected over the computer network corresponding to a user and one or more receivers of said communications, comprising:
a message handler component including a plurality of APIs for handling second layer data portions according to a plurality of user-defined responsibilities each of said APIs is configured to perform, and for configuring said second layer data portions for distribution to a plurality of channels according to which of a plurality of formats each of said second layer data portions resembles;
a channel layer component including a plurality of channels arranged according to which of said plurality of formats each of said second layer data portions resembles, said channel layer for multiplexing said second layer data portions into first layer data portions and channeling said first layer data portions according to which of said plurality of channels each of said first layer data portions is directed to; and
a socket layer component for receiving, multiplexing, disassembling and refragmenting said first layer data portions of each of said channels into one or more data packets, and communicating said one or more data packets over said network to one or more receivers corresponding to one or more processors over said network.

34. The program of claim 33, said socket layer further for incorporating header data within said one or more data packets for associating said one or more data packets with said user.

35. The program of claim 33, said socket layer further for establishing a communications session between said user and at least a first of said one or more receivers, and sending a handshaking request to a first processor corresponding to said first receiver.

36. The program of claim 35, said socket layer further for incorporating header data within said one or more data packets for associating said one or more data packets with said user.

37. The program of claim 36, said socket layer further for exchanging generalized data specific to the first receiver and the user.

38. The program of claim 37, said generalized data including one or more of host URI, UUID and IP.

39. The program of claim 38, said channel layer further for resolving said one or more of said host URI, UUID, and IP generalized data.

40. The program of claim 37, said generalized data including prior communication history data between said first receiver and user.

41. The program of claim 33, said channel layer further for prioritizing one or both of said first and second layer data portions based on a flexible hierarchy of priorities.

42. The program of claim 41, said channel layer further for updating said flexible hierarchy of priorities as said priorities evolve based on status and activities of said user.

43. The program of claim 42, said channel layer further for updating said flexible hierarchy of priorities as said priorities evolve based on status and activities of said first receiver.

44. The program of claim 41, said channel layer further for updating said flexible hierarchy of priorities as said priorities evolve based on status and activities of said first receiver.

45. The program of claim 33, said plurality of formats including two or more of voice, text, data, graphic, audio, video and combinations thereof.

46. The program of claim 33, said socket layer further for communicating said one or more data packets over said network to a first receiver corresponding to a first processor and a second receiver corresponding to a second processor.

47. The program of claim 46, said socket layer further for incorporating header data within said one or more data packets for associating said one or more data packets with said user.

48. The program of claim 46, said socket layer further for establishing a communications session between said user and said first and second receivers, and sending a handshaking request to said first and second processors.

49. The program of claim 48, said socket layer further for incorporating header data with said one or more data packets for associating said one or more data packets with said user.

50. The program of claim 49, said socket layer further for exchanging first and second generalized data specific to the first and second receivers, respectively, and the user.

51. The program of claim 50, said generalized data including one or more of host URI, UUID and IP.

52. The program of claim 51, said channel layer further for resolving said one or more of said host URI, UUID, and IP generalized data.

53. The program of claim 51, said first and second generalized data including prior communication history data between said first and second recievers, respectively, and the user.

54. The program of claim 46, said channel layer further for prioritizing one or both of said first and second layer data portions based on a flexible hierarchy of priorities.

55. The program of claim 54, said channel layer further for updating said flexible hierarchy of priorities as said priorities evolve based on status and activities of said user.

56. The program of claim 55, said channel layer further for updating said flexible hierarchy of priorities as said priorities evolve based on status and activities of said first and second receivers.

57. The program of claim 54, said channel layer further for updating said flexible hierarchy of priorities as said priorities evolve based on status and activities of said first and second receivers.

58. The program of claim 33, further comprising a compression/encryption layer for compressing and encrypting said one or more data packets depending on a user defined state of compression and encryption of said data packets.

59. The program of claim 33, further comprising a monitoring layer for tracking data exchanges between said user and said recipients.

60. The program of claim 33, further comprising a data aggregation layer for aggregating data communicated by said user.

61. The program of claim 33, further comprising a developer added layer for performing responsibilities defined by a developer.

62. The program of claim 33, further comprising:
a compression/encryption layer for compressing and encrypting said one or more data packets depending on a user defined state of compression and encryption of said data packets;
a monitoring layer for tracking data exchanges between said user and said recipients;
a data aggregation layer for aggregating data communicated by said user; and
a developer added layer for performing responsibilities defined by a developer.

63. A method for permitting and extracting communications from TCP/IP between hardware components including a plurality of processors connected over the computer network corresponding to one or more senders and a user of said communications, comprising the operations:
receiving one or more data packets from a first processor corresponding to a first sender via said network;
defragmenting and reassembling data of said one or more data packets;
demultiplexing and distributing first layer data portions of said one or more data packets into a plurality of channels according to which of a plurality of formats each of said first layer data portions resembles;
further demultiplexing and distributing second layer data portions of said first layer data portions according to which of a plurality of APIs each of said second layer portions is directed to; and
handling said second layer data portions according to a plurality of user-defined responsibilities each of said APIs is configured to perform.

64. The method of claim 63, further comprising the operation associating said one or more data packets with said first sender based on header data within said one or more data packets.

65. The method of claim 63, further comprising the operations:
establishing a communications session between said user and said first sender; and
sending a handshaking request response to said first processor.

66. The method of claim 65, further comprising the operation associating said one or more data packets with said first sender based on header data within said one or more data packets.

67. The method of claim 66, further comprising the operation exchanging generalized data specific to the first sender and the user.

68. The method of claim 67, said generalized data including one or more of host URI, UUID and IP.

69. The method of claim 68, further comprising the operation resolving said one or more of said host URI, UUID, and IP generalized data.

70. The method of claim 67, said generalized data including prior communication history data between said first sender and user.

71. The method of claim 63, further comprising the operation verifying and evaluating said data packet in a checksum subroutine.

72. The method of claim 63, further comprising the operation prioritizing one or both of said first and second layer data portions based on a flexible hierarchy of priorities.

73. The method of claim 72, further comprising the operation updating said flexible hierarchy of priorities as said priorities evolve based on status and activities of said user.

74. The method of claim 73, further comprising the operation updating said flexible hierarchy of priorities as said priorities evolve based on status and activities of said first sender.

75. The method of claim 72, further comprising the operation updating said flexible hierarchy of priorities as said priorities evolve based on status and activities of said first sender.

76. The method of claim 63, said plurality of formats including two or more of voice, text, data, graphic, audio, video and combinations thereof.

77. The method of claim 63, further comprising the operation decompressing/decrypting said one or more data packets depending on a state of compression and encryption of said data packets.

78. The method of claim 63, further comprising the operation monitoring data exchanges between said user and said first sender.

79. The method of claim 63, further comprising the operation aggregating data communicated by said first sender.

80. The method of claim 63, further comprising the operation performing responsibilities defined by a developer.

81. The method of claim 63, further comprising the operations:
decompressing/decrypting said one or more data packets depending on a state of compression and encryption of said data packets;
monitoring data exchanges between said user and said first sender;
aggregating data communicated by said first sender; and
performing responsibilities defined by a developer.

82. A method for permitting and extracting communications from TCP/IP between hardware components including a plurality of processors connected over the computer network corresponding to a user and one or more receivers of said communications, comprising the operations:
handling second layer data portions according to a plurality of userdefined responsibilities each of one or more APIs is configured to perform;
configuring said second layer data portions for distribution to a plurality of channels according to which of a plurality of formats each of said second layer data portions resembles;
multiplexing said second layer data portions into first layer data portions;
channeling said first layer data portions according to which of said plurality of channels each of said first layer data portions is directed to;
receiving, multiplexing, disassembling and refragmenting said first layer data portions of each of said channels into one or more data packets; and
communicating said one or more data packets over said network to one or more receivers corresponding to one or more processors over said network.

83. The method of claim 82, further comprising the operation incorporating header data within said one or more data packets for associating said one or more data packets with said user.

84. The method of claim 82, further comprising the operations:
establishing a communications session between said user and at least a first of said one or more receivers; and
sending a handshaking request to a first processor corresponding to said first receiver.

85. The method of claim 84, further comprising the operation incorporating header data within said one or more data packets for associating said one or more data packets with said user.

86. The method of claim 85, further comprising the operation exchanging generalized data specific to the first receiver and the user.

87. The method of claim 86, said generalized data including one or more of host URI, UUID and IP.

88. The method of claim 87, further comprising the operation resolving said one or more of said host URI, UUID, and IP generalized data.

89. The method of claim 86, said generalized data including prior communication history data between said first receiver and user.

90. The method of claim 82, further comprising the operation prioritizing one or both of said first and second layer data portions based on a flexible hierarchy of priorities.

91. The method of claim 90, further comprising the operation updating said flexible hierarchy of priorities as said priorities evolve based on status and activities of said user.

92. The method of claim 91, further comprising the operation updating said flexible hierarchy of priorities as said priorities evolve based on status and activities of said first receiver.

93. The method of claim 90, further comprising the operation updating said flexible hierarchy of priorities as said priorities evolve based on status and activities of said first receiver.

94. The method of claim 82, said plurality of formats including two or more of voice, text, data, graphic, audio, video and combinations thereof.

95. The method of claim 82, further comprising the operation communicating said one or more data packets over said network to a first receiver corresponding to a first processor and a second receiver corresponding to a second processor.

96. The method of claim 95, further comprising the operation incorporating header data within said one or more data packets for associating said one or more data packets with said user.

97. The method of claim 95, further comprising the operations:
establishing a communications session between said user and said first and second receivers; and
sending a handshaking request to said first and second processors.

98. The method of claim 97, further comprising the operation incorporating header data with said one or more data packets for associating said one or more data packets with said user.

99. The method of claim 98, further comprising the operation exchanging first and second generalized data specific to the first and second receivers, respectively, and the user.

100. The method of claim 99, said generalized data including one or more of host URI, UUID and IP.

101. The method of claim 100, further comprising the operation resolving said one or more of said host URI, UUID, and IP generalized data.

102. The method of claim 99, said first and second generalized data including prior communication history data between said first and second recievers, respectively, and the user.

103. The method of claim 95, further comprising the operation prioritizing one or both of said first and second layer data portions based on a flexible hierarchy of priorities.

104. The method of claim 103, further comprising the operation updating said flexible hierarchy of priorities as said priorities evolve based on status and activities of said user.

105. The method of claim 104, further comprising the operation updating said flexible hierarchy of priorities as said priorities evolve based on status and activities of said first and second receivers.

106. The method of claim 103, further comprising the operation updating said flexible hierarchy of priorities as said priorities evolve based on status and activities of said first and second receivers.

107. The method of claim 82, further comprising the operation compressing/encrypting said one or more data packets depending on a user defined state of compression and encryption of said data packets.

108. The method of claim 82, further comprising the operation monitoring data exchanges between said user and said recipients.

109. The method of claim 82, further comprising the operation aggregating data communicated by said user.

110. The method of claim 82, further comprising the operation performing responsibilities defined by a developer.

111. The method of claim 82, further comprising the operations:
compressing/encrypting said one or more data packets depending on a user defined state of compression and encryption of said data packets;
monitoring data exchanges between said user and said recipients;
aggregating data communicated by said user; and
performing responsibilities defined by a developer.
